(19) United States
(12) Patent Application Publication
(10) Pub. No.: US 2007/0010944 A1
(43) Pub. Date: Jan. 11, 2007

(54) Driver-adjustable sensor apparatus, system, & method for improving traffic safety

(76) Inventors: James Harrison Ferrebee JR., Shawboro, NC (US); Edmund Fletcher Humphries, Moyock, NC (US); Frank Hudgins III, Virginia Beach, VA (US); David Russell, Virginia Beach, VA (US)

Correspondence Address: DAVID RUSSELL, PO BOX 913, VIRGINA BEACH, VA, 23451, US

(21) Appl. No.: 11/177,767

(22) Filed: Jul. 9, 2005

(51) Int. Cl. G08G 1/00

(52) U.S. Cl. 701/301; 701/117

(57) ABSTRACT

The present invention discloses methods, apparatuses, and a system for improving intervehicular traffic safety by facilitating driver awareness of nearby vehicular traffic activity. Methods are disclosed for monitoring, detecting, and tracking “adjacent vehicles” (AVs) and “adjacent vehicle movements” (AVMs); calculating and displaying AV/AVM status data; and recommending and/or executing intervehicular maneuvering actions as needed. A driver-adjustable sensor apparatus is disclosed, allowing driver adjustment of AV/AVM “detection perimeters” (to increase/decrease detection ranges) based on traffic conditions, driver preferences, triggering of legal or preset thresholds, etc. Multiple versions of a “driver-adjustable” sensor and display system monitor, detect, and track traffic adjacent to a reference vehicle; calculate and display AV/AVM status data; and recommend and/or execute routine or emergency maneuvering actions needed to maintain vehicle safety during congestion or other intervehicular events. Better driver awareness and improved traffic safety are the result. The invention is factory-installed or purchased as an aftermarket product.

### BACKGROUND OF THE INVENTION

1. Field of the Invention

The field of the invention is facilitating and improving traffic safety and driver awareness by improving intervehicular intelligence; more particularly, the invention improves the real-time traffic monitoring, detection, and tracking of adjacent vehicles (“AVs”) and adjacent vehicle movements (AVMs), as well as calculating AVM status data using a vehicle-based, driver-adjustable traffic detection apparatus and system.

Detection is effectuated by using wireless electromagnetic (and other) radiators and detection sensors.

2. Related Art

The present invention adjustably monitors and detects road area directly surrounding a vehicle in all directions, regardless whether the vehicle is standing still or in motion. By contrast, other inventors have to a certain extent preliminarily addressed some issues of traffic safety, e.g., detecting and determining ongoing changes in roads and traffic loads. However, none of the inventions reviewed has definitively solved traffic safety problems. None have offered comprehensive traffic management and detection. None have created an invention around which the industry has been able to standardize—nor is it likely that any 100% effective and comprehensive traffic management system is possible or can ever be created.

Notwithstanding, the Inventors submit that the method, apparatus, and system disclosed as the present inventions herein uniquely addresses traffic management and detection challenges.

U.S. Pat. No. 4,467,313 to Yoshino, et al, discloses an automotive rear safety checking apparatus which comprises a plurality of obstacle detectors mounted on the rear part of the automobile for radiating ultrasonic waves on areas smaller in width than the width of the automobile, and for detecting the ultrasonic wave reflected from an obstacle.

U.S. Pat. No. 5,983,161 to Lemelson discloses a GPS vehicle collision avoidance warning and control system and method. The patent describes use of GPS satellite ranging signals from a fixed known earth base station received on a communications receiving port on one of a plurality of vehicles/aircraft/automobiles which GPS signals are processed to continuously determine the one's kinematic tracking position on a pathway. The GPS position is communicated with selected other status information to each other one of the plurality of vehicles, to the one station, and/or to one of a plurality of control centers, and the one vehicle receives therefrom each of the others' status information and kinematic tracking position.

U.S. Pat. No. 6,337,638 to Bates, et al, discloses a vehicle warning system and method based on speed differential. The invention provides a method, apparatus, and article of manufacture for detecting the presence of one or more target vehicles and determining a distance and speed of the targeted vehicles relative to a targeting vehicle. When predetermined threshold comditions are satisfied, warning signals are output from a computer system to alert a driver of the one or more targeted vehicles. In addition, steps may be taken to determine whether the targeting vehicle and the one or more targeted vehicles will converge to created a congested condition. If so, the speed of the targeting vehicle can be adjusted.

U.S. Pat. No. 6,559,761 to Miller, et al, discloses a display system for vehicle environment awareness. The invention is an overhead-view display system for a vehicle. The display system comprises a reference vehicle indicator within an overhead field of view and at least three field of view display segments. Each display segment represents a physical region adjacent the reference vehicle and includes a first indicator adapted to display the existence of another vehicle within the region and the relative distance between the reference vehicle and the other vehicle. In another embodiment, each field of view display segment includes a second indicator adapted to represent a direction of change of relative distance between the reference vehicle and the other vehicle, and possibly the vehicle types. The, the disclosed display system communicats information on the vehicle's operating environment to the vehicle operator quickly, completely and with minimal driver distraction.

U.S. Pat. No. 6,677,856 to Perlman, et al, discloses a remote motor vehicle signal indicator system consisting of a transmitter coupled to a vehicle indication signal drive line. The transmitter wirelessly transmits a receiver activation signal corresponding to a vehicle indication signal of the vehicle indication signal drive line. The vehicle indication signal is selected from the group consisting of a turn signal, a brake signal, a reverse gear signal, and a hazard signal. The system also includes a remote vehicle signal indicator coupled to a surface outside of the vehicle and includes a signal indicator display. The remote vehicle signal indicator receives the receiver activiation signal from the transmitter and, in response, activates the signal indicator display. In some variations, a power supply not coupled to the vehicle power supply powers the remote vehicle signal indicator and the transmitter is powered by the vehicle indication signal.

U.S. Pat. No. 6,813,561 to MacNeille, et al, discloses a relative vehicle positioning system for a vehicle including a GPS antenna adapted to receive satellite signals generated in response to relative vehicle positioning and generate therefrom a GPS signal. A Bluetooth radio is adapted to exchange bearing information with a second vehicle and generate therefrom a BPT signal. A GPS unit including a controller is adapted to receive the GPS signal and the PVT signal, the GPS unit is further adapted to generate therefrom a GPS-Bluetooth relative position signal.

U.S. Pat. No. 6,861,957 to Koike discloses an apparatus with positional data utilizing an inter-vehicle communication method and a traveling control apparatus. Predicted future positions are calculated and arranged into packets to be transmitted using a communication pattern based on a time and a position of each packet. Another vehicle calculates its predicted position and generates a communication pattern based on a result of calculation so that the generated communication pattern is utilized for reception. Consequently, data associated with a future position of its own can be selected for enabling reception. An existence probability is calculated, and the state of another vehicle can be accurately understood from the communication of the calculated existence probability, thereby effectively reducing chance of collision.

### NECESSITY OF THE INVENTION

The Inventors have observed these and other issued patents purporting to directly or indirectly address and/or ameliorate and/or report on instantaneous traffic safety challenges associated with underway road safety situations involving single or multiple vehicles. Although the patents issued and the products they protect apparently do offer some benefits, it is our contention that existing patents and products are either expensive to produce, and/or cumbersome to implement and use, and/or unnecessarily elaborate in design and function, and/or difficult to calibrate, and/or are not driver-adjustable. Accordingly, the present invention discloses an ergonomic, economical-to-manufacture, apparatus and system for monitoring, detecting, and tracking AVs and AVMs. Optional versions of the invention can broadcast a driver's reference vehicle's movement intentions to other adjacent vehicles, as well as make maneuvering recommendations and/or automatically execute maneuvering recommendations if needed and feasible.

The apparatus, system, and method of the present invention are relatively easy to implement and intuitive to use, simple in design and function, and easily calibrated and adjusted by a driver. The apparatus, system, and method of the present invention are particularly traffic-safety-oriented, and can be either installed at the factory or as an after-market automotive product (albeit likely not as precise in function as a factory-installed version).

### OBJECTS OF THE INVENTION

Accordingly, it is one primary object of the present invention, to improve and/or facilitate traffic safety and driver awareness of adjacent traffic conditions by providing a vehicle-based safety system for monitoring, detecting, and tracking adjacent vehicles (AVs) and reporting and displaying adjacent vehicle movements (AVMs) to drivers, thereby improving traffic safety by facilitating safer driving decisions.

It is a related primary object, to provide a flexible, driver-adjustable, vehicle-based traffic safety improvement system: (a) for detecting “live” AVs and AVMs; (b) for analyzing AVMs and for calculating, reporting, and displaying AVM status data; and (d) for making maneuvering recommendations when needed. Regarding (d)—“maneuvering recommendations”—it's a related object of the invention, to provide a system (i) for displaying AVM status data; and/or (ii) for recommending suggested driver maneuvers, based on AVMs and/or IVM signals; and/or (iii) for executing automatic preprogrammed emergency maneuvers when a vehicle is in imminent danger (i.e., “in extremis”) based on AVMs and/or IVM signals.

Another related object, is to provide a system for 2-way, inter-vehicle communications. Still another related object of the invention is to provide a system which allows a second vehicle to challenge IVM (intended vehicle movements) signals and/or AVMs (adjacent vehicle movements) of a first vehicle while both vehicles are moving in traffic. It is another primary object, to provide a vehicle-based system for transmitting and receiving IVM (intended vehicle movement) data.

It is another primary object, to provide a variable, driver-adjustable AVM sensor apparatus which will allow a driver to adjust and vary the detection perimeters of the AVM detection subsystem.

It is another primary object, to provide a display for displaying AVM/IVM status data including pictographic AVM/IVM “vectors”, an AVM/IVM “tote board”, and AVM/IVM emergency maneuvering recommendations.

It is another primary object of the invention, to provide a vehicle-based system for predicting, handling, and averting controllable traffic problems calculating and using emergency course(s), speed(s), and/or maneuver(s) to reduce or eliminate collisions.

### SUMMARY OF THE INVENTION

The present invention discloses methods, apparatuses, and a system for improving traffic safety, using the display and other features of the present invention.

Methods are disclosed for monitoring AVMs (“adjacent vehicle movements”) after detecting AVMs/AVM data; calculating AVM status data, displaying AVMs/AVM data/AVM status data; and recommending maneuvering actions when needed. Versions of a driver-adjustable sensor apparatus are disclosed, that allow drivers to vary one or more “detection perimeters”—i.e., increase or decrease scales and/or ranges of traffic event detection and/or display results at closer or longer range-depending on traffic conditions and driver preferences, either manually or automatically. Multiple versions of a vehicle-based, “driver-adjustable” sensor system are disclosed, which monitor traffic, detect AVMs and AVM data; calculate AVM status data; display AVM data and AVM status data; and recommend urgent maneuvering as needed to maintain vehicle safety in traffic. The result and benefit of the invention, is the improvement of traffic safety.

The driver-controllable Adjacent Vehicle detection system is virtually infinitely variable in detection capabilities (within the limits of the system implemented), so any driver can select and adjust their Adjacent Vehicle detection perimeter ranges {P1, P2} to suit optimum personal preferences.

Additionally, the present invention discloses a traffic control apparatus comprising a traffic light adapted to transmit a yellow light warning signal to a vehicle equipped to receive it. The processor embedded in the traffic light of the present invention—which controls the timing/changing of the light from green to yellow to red-—detects when the light has turned to yellow. The processor then relays a “yellow light detected” message to a transmitter embedded in the light, which transmits (broadcasts) a “yellow light warning signal” to any vehicle equipped to receive it.

### BRIEF DESCRIPTION OF FIGURES AND REFERENCE NUMERALS

### Brief Description of Figures

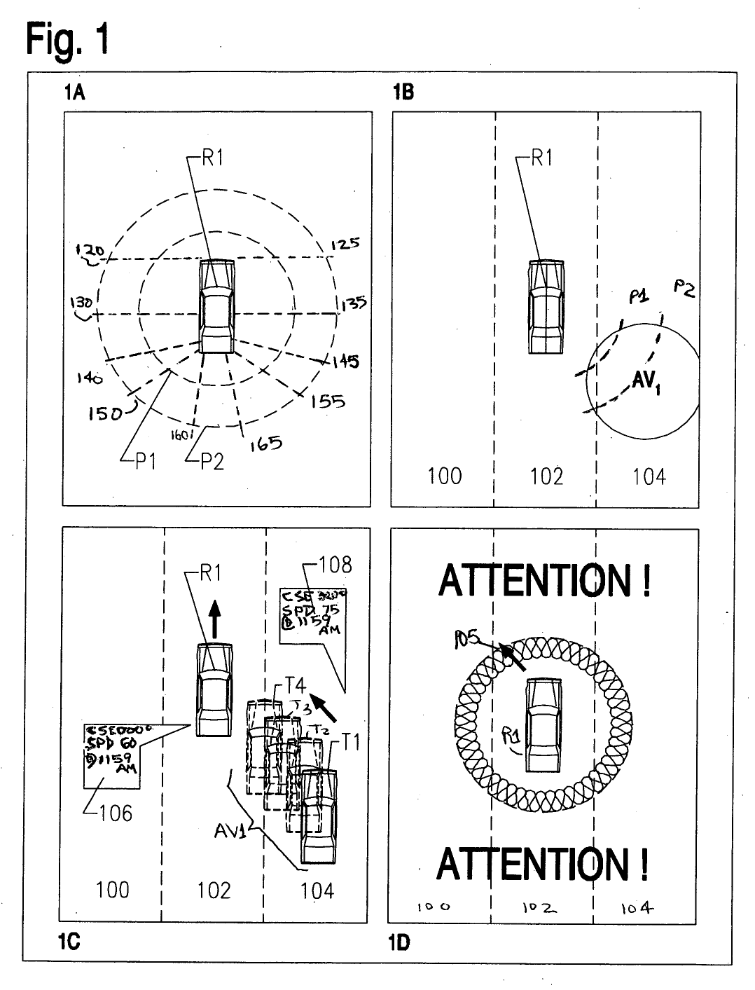

FIG. 1 is a composite with four (4) panels, Panel 1A, Panel 1B, Panel 1C, and Panel 1D, depicting screen display modes (1A) Monitoring; (1B) Detecting; (1C) Tracking; and (1D) Manuevering Recommendations.

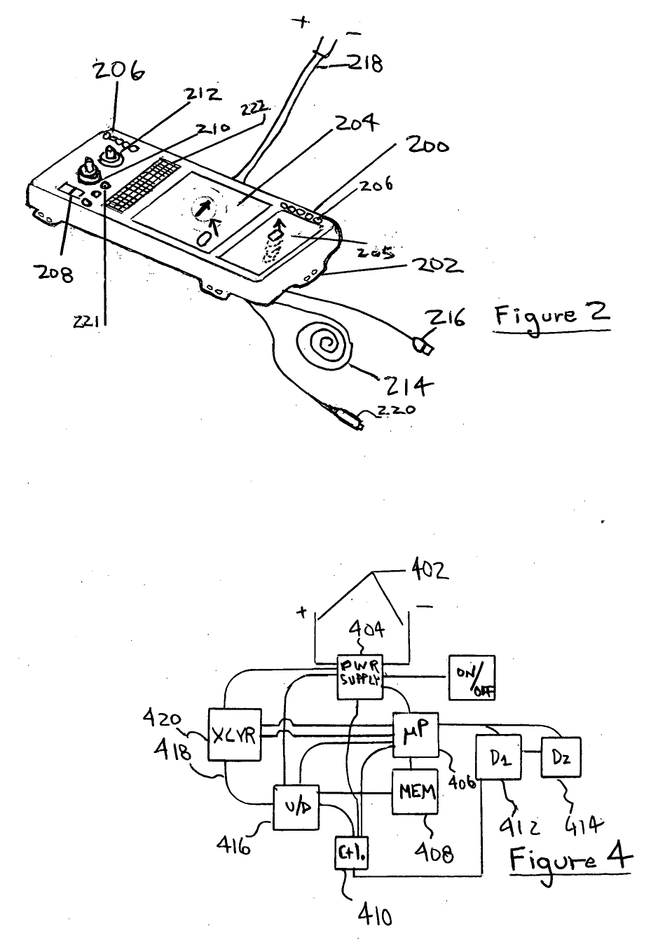

FIG. 2 shows the primary module of a modular, uninstalled, aftermarket version of the Driver Adjustable Sensor System.

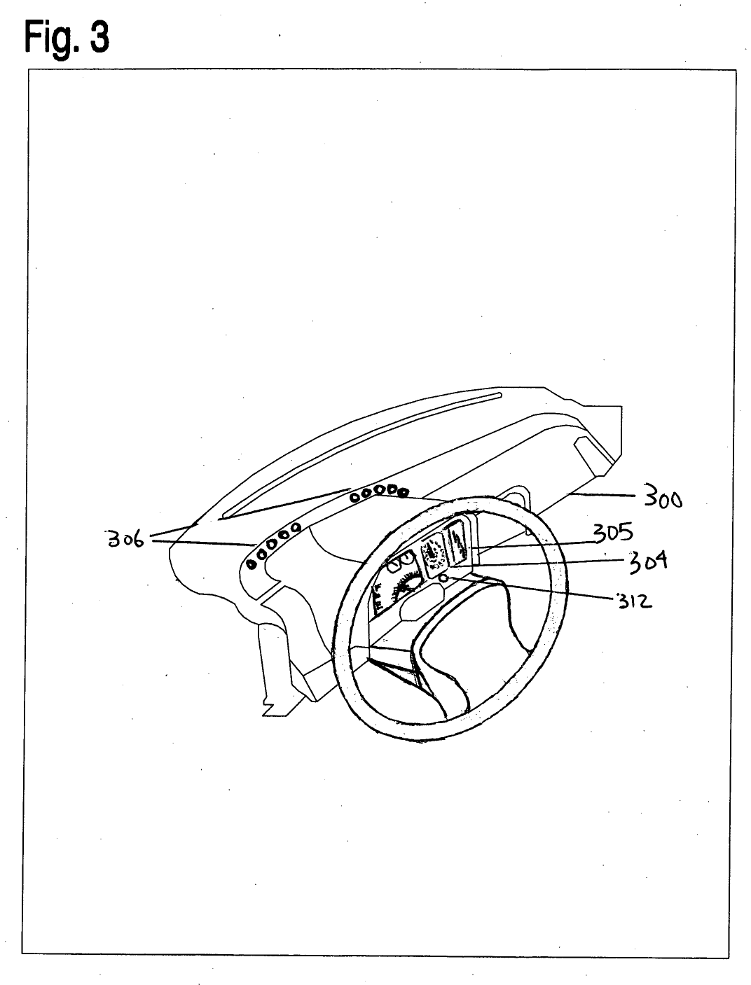

FIG. 3 shows a dashboard-embedded version of the Driver Adjustable Sensor System.

FIG. 4 shows a block diagram of some of the primary electronics of the driver-adjustable sensor system.

### REFERENCE NUMERALS

FIG. 1:

Panel 1A: Monitoring

R1: Reference Vehicle
P1: Nearest Detection Perimeter
P2: Farthest Detection Perimeter
120 Left-side forward sensor module emplacement & wave propagation
130 Left-side midcar sensor module emplacement & wave propagation
140 Left-side quarter panel sensor 1 emplacement & wave propagation
150 Left-side quarter panel sensor 2 emplacement & wave propagation
160 Left-side quarter panel sensor 3 emplacement & wave propagation
125 Right-side forward sensor module emplacement & wave propagation
135 Right-side midcar sensor module emplacement & wave propagation
145 Right-side quarter panel sensor 1 emplacement & wave propagation
155 Right-side quarter panel sensor 2 emplacement & wave propagation
165 Right-side quarter panel sensor 3 emplacement & wave propagation
   Panel 1B
R1: Reference Vehicle
P1: Nearest Detection Perimeter
P2: Farthest Detection Perimeter
AV1: Adjacent Vehicle 1 crossing P2 & P1 thresholds
100 left lane
102 center lane
104 right lane
   Panel 1C
R1: Reference Vehicle
AV1: Closing Bearing, Decreasing Range to Reference Vehicle
100 left lane
102 center lane
104 right lane
106 Course/Speed/Track Info Pop-up: “Course 000°/Speed 60 mph/1159 AM”
108 Course/Speed/Track Info Pop-up: “Course 320°/Speed 75 mph/1159 AM”
T1, T2, T3, T4: successive time intervals, all shown tracking AV1
   Panel 1D
R1: Reference Vehicle
AV1: Collision Course (from Panel 1C) Triggers Visual & Audible Alarms
100 Left Lane
102 Center Lane
104 Right Lane
“ATTENTION!” visual alarm legend (warning screen)
   105 Maneuvering Recommendation Vector (course to steer direction)
   FIG. 2:
200 Enclosure & Detection Sensor Control Module
202 Enclosure Mounting Flanges
204 Main Display Subsystem
205 Auxiliary Display Subsystem
206 Auxiliary “Bogey Display” Light Groups (Right-side & Left-side)
208 Power ON/OFF Switch
210 Display Intensity Control Dial
212 Driver-Adjustable Detection Perimeter Settings Dial (controls P1, P2)
214 Antenna connected to Transceiver Interface
216 USB interface, male plug
218 Power Cable, interface to 12V car battery
220 Power Probe, for Dashboard Lighter & 12V car battery
221 Control for speaker volume
222 Speaker for audible alarm signals and synthesized voice outputs
   FIG. 3:
304 Main Display Subsystem
305 Maneuvering Recommendations Display Screen
306 Auxiliary Right-side & Left-side “Bogey Display” Light Groups
312 Driver-Adjustable, Detection Perimeter Settings Control Dial
   FIG. 4:
402 Car Battery Interface
404 Sensor System Power Interface/Power Supply
406 Microprocessor
408 Memory
410 Video Controller for Display
412 Main Display
414 Auxiliary Display
416 Uplink/Downlink Interface to Antenna
418 Transceiver to Uplink/Downlink Interface
420 Tranceiver

### DETAILED DESCRIPTION OF THE INVENTION

FIG. 1 shows four (4) panels of typical display screens displaying traffic information. The traffic information is detected, tracked, and displayed by the driver-adjustable sensor system.

Panel 1A shows a toggle-able (i.e., having Function/2^{ND} Function multiple display capability) “Monitoring Mode/Detection Perimeter Settings Mode” display screen. Reference vehicle R1 (representing the driver's vehicle) is shown center screen (while toggled to Detection Perimeter Settings Mode). Dotted concentric circles represent “nearest” detection perimeter P1 and “farthest” detection perimeter P2. Here, e.g., Detection Perimeter settings {P1, P2} are set by the driver to: {P1=7.5 Meters, P2=4 Meters} measured from the middle of R1; however, any available settings can be used—or varied and changed, manually or automatically—to suit road conditions. Also, any driver using reference vehicle R1 can change settings of P1 and P2 to suit their own individual preferences. (NB: Detection Perimeters P1 and P2 are depicted using circular perimeters; however, other perimeter shapes can be customized based on driver preferences.) Finally, the transceiver/antenna electronics are optimally located approximately in the middle area of R1 to simplify detection perimeter measuring and calculations (e.g., on a car roof), but other transceiver/antenna locations are possible. Also shown on Panel 1A are locations of radio wave sensor module emplacements and their propagations, all disposed about reference vehicle R1 (sensor modules themselves are not shown), comprising sensor module emplacements and sensor module radio wave propagation lines 120, 125, 130, 135, 140, 145, 150, 155, 160, 165. These represent radio transmissions from R1's plurality of sensor modules used as AV detectors (modules not shown), which detect to the approximate ends of the detection perimeters P1 and P2 (however they are set by the driver). When these radio waves are propagated out, if they strike an adjacent vehicle falling within the detection perimeters as set, the radio waves echo the presence of the vehicle, and display the detected result (e.g., one or more adjacent vehicles) on one or more display screens (see Panels 1B, 1C, 1D).

Panel 1B overviews a Detecting Mode display screen showing a 3-lane highway with a reference vehicle R1 (a “first” vehicle) shown in center lane 102 plus an adjacent vehicle AV1 located on the right passenger side quarter panel area in right lane 104, apparently moving toward reference vehicle R1, with AV1 passing through first the P2 threshold and then the P1 threshold as shown.

Panel 1C overviews a Tracking Mode display screen showing reference vehicle R1 in the center of the display screen and AV1 Time/Range/Speed Vectors T1, T2, T3, T4. Also shown in Panel 1C are Detection Parameters Pop-Ups 106 and 108, with can be variously configured to provide (e.g.) range, bearing, direction of relative motion, course and speed magnitude vectors of R1 and AV1, depending on implementation. This data comprises adjacent vehicle movement (AVM) data, AVM status data, and other data and information depending on settings, detected data, emergency events, etc.

Panel 1D shows a Recommended Maneuvers display screen showing a “Best Safe Track” extrapolation and a “Turn Recommendation” (105). Panels 1B, 1C, and 1D are all representative of typical display screens used in the present invention. These are only a few of the possible options of toggleable displays that can be implemented.

FIG. 2 shows a close-up of one modular uninstalled version of an aftermarket Traffic Safety System showing the enclosure of the primary module 200; the display screen 204 and auxiliary display and maneuvering recommendations and auxiliary display screen 205. Also shown are left and right side auxiliary “Bogey Display” light groups 206 (left and right side group of 5 lights each as shown) which light singly or in groups signifying the approach of an AV, based on P1/P2 settings; ON/OFF switch 208, display intensity control 210, the combined (stacked) driver adjustable detection perimeter P1 and P2 sensor control 212 for setting P1 and P2 detection perimeter ranges. USB interface male plug 216 is an interface that can be used to connect to an auxiliary processor and/or other power source implemented through a USB fitting. FIG. 2 also shows optional power cable to car battery 218; an optional power cable probe 220 can be plugged into the car auxiliary power (cigarette lighter) accessory; antenna interface 214; attachment flanges 202 for affixing and retrofitting the add-on module onto a vehicle dashboard. Also shown is a speaker volume control 221 and speaker 222 adapted for issuing audible alarms and/or synthesized voice outputs, as an adjunct to visual capabilities for issuing alerts, alarms, warnings, pre-programmed navigational comments, etc., depending on configuration details.

FIG. 3 shows a dashboard embedded version of the driver adjustable sensor system. The onboard, factory-installed dashboard version of the present invention is installed into dashboard 300, during assembly of the automobile. Also shown is display screen 304, maneuvering recommendations auxiliary display screen 305, as well as right-side and left-side “bogey detector” lights groups 306. The detector lights 306 can be implemented in many different ways, e.g., they can light singly on the leftmost or rightmost sides—when an adjacent (“bogey”) vehicle is first detected on the left or right side—then a second, third, etc. additional “bogey detector” light can be lit up as an adjacent vehicle moves incrementally closer to a reference vehicle R1. A driver adjustable control 312 is also shown, which is used for setting detection perimeters P1 and P2. All other options as shown on FIG. 2 can also be implemented, if chosen.

FIG. 4 shows a summary block diagram of primary electronics of the driver-adjustable sensor system of the present invention. 402 shows the car battery interface. 404 shows the sensor system power interface power supply, including voltage regulators or other power management circuitry, if any. 406 shows the microprocessor which is interfaced with the transceiver subsystem. 408 shows the memory which is auxiliary to processor-based memory. 412 and 414 represent the display screens. 416 is an “uplink/downlink module”, serving the transmitter/receiver (transceiver) 420. 418 is the interface connection between the transceiver 420 and the uplink/downlink module 416.

Additionally, there is no illustration of the traffic control system comprising the traffic light of the present invention, because the traffic control system of the invention looks essentially the same as a standard, conventional traffic light. The traffic control system is capable of generating a “Yellow Light Warning Signal” which is transmitted from the light to any vehicle equipped to receive it. The transmitter within the light transmits the Yellow Light Warning Signal when triggered to do so by the processor within the traffic light, which triggers the transmission after detecting the yellow light has been illuminated. Other vehicle side structural implementations associated with the reception of the Yellow Light Warning Signal can include forced and/or recommended “vehicle stopping and/or braking commands” which can be autonomously executed by the vehicle, including forced braking and/or forced stopping before entering an intersection; i.e., the vehicle equipped to respond to the Yellow Light Warning Signal can be configured respond in a variety of ways, depending on the implementation by the vehicle owner. For example, a school bus could be implemented with not only a speed governance system but also a braking and/or an emergency maneuvering capability. A new 16-year-old driver could be required to drive with additional constraints governed by the system, as defined and implemented by the young driver's parents, e.g.; or a driver with many traffic citations could be forced by the DMV to drive a vehicle with many additional safety constraints. A CVISN (commercial vehicle information system network) system could be implemented which has control interfaces to vehicles equipped with advanced versions of the present invention. Many other combinations will be obvious to one skilled in the art, after reading the teachings disclosed herein.

While a current embodiment of the present invention has been described in detail, it should be apparent to one skilled in the art, that modifications and variations thereto are possible, all of which fall within the true spirit and scope of the present invention. With respect to the above description and specification, it will be realized that the “optimum” dimensional relationships for the parts of the invention can vary, including variations in size, materials, shape form, function, and manner of operation, assembly, and use. All equivalent relationships to those illustrated in the drawings and described in the specification are intended to be encompassed by the present invention. Therefore, the foregoing is considered as illustrative only of the principles of the present invention. Further, since numerous modifications and changes will readily occur to those skilled in the art, it is not desired to limit the invention to the exact or approximate construction and operation shown and described, and accordingly, all suitable modifications and equivalents may be resorted to, falling within the scope of the present invention.

We claim:

1. A method for improving intervehicular traffic safety, the steps comprising:
a. equipping a reference vehicle with a driver-adjustable sensor for sensing adjacent vehicles (AVs) and adjacent vehicle movements (AVMs);
b. adjusting and setting at least one detection perimeter of said driver-adjustable sensor by the driver of said reference vehicle;
c. monitoring, detecting and tracking in said reference vehicle at least one AV crossing within said at least one detection perimeter;
d. calculating “live” AVM status data by processing AVMs of said at least one AV crossing within said at least one detection perimeter;
e. recommending and displaying at least one maneuvering recommendation when necessary to help maintain vehicle safety; and
f. accepting and executing said at least one maneuvering recommendation by at least one of a driver-initiated emergency maneuver and an automatic preprogrammed emergency maneuver autonomously executed by said reference vehicle.

2. The method of claim 1, wherein said “live” AVM status data further comprises (but is not limited to) at least one of location data, direction of motion data, direction of relative motion data, range data, bearing data, speed data, closest point of approach data, closure rate data, collision probability data, and additional driver-stipulated data pertaining to at least one of said AVs when compared with a reference vehicle after detection of said at least one AV crossing within said at least one detection perimeter of said reference vehicle.

3. The method of claim 1, wherein the step of adjusting and setting said at least one detection perimeter also includes the step of setting at least one of a P1 detection perimeter and a P2 detection perimeter.

4. The method of claim 1, wherein the step of recommending and displaying said at least one maneuvering recommendation also includes the step of displaying at least one display screen showing successive AVM status data updates of said at least one AV crossing within said at least one detection perimeter.

5. The method of claim 1, wherein the step of calculating “live” AVM status data further includes providing data updates at a driver-selected update frequency and occurs while said reference vehicle is in motion.

6. The method of claim 1, wherein the step of calculating “live” AVM status data further includes providing data updates at a driver-selected update frequency and occurs while said reference vehicle is stopped.

7. The method of claim 4, further including the step of visually displaying a simulated overhead view of said at least one AV and displaying said successive AVM status data updates relevant to said at least one maneuvering recommendation.

8. The method of claim 7, further including at least one of the steps of audibly sounding a warning sound and visually displaying a warning image of said at least one maneuvering recommendation represented as pictographic data.

9. The method of claim 6, wherein display of said successive AVM status data updates includes (but is not limited to) at least one of course update data and a speed update data pertaining to said at least one AV.

10. The method of claim 1, additionally including the step of signaling and broadcasting IVMs (intended vehicle movements) by said reference vehicle, wherein said IVMs further comprise proposed intended vehicle movements of said reference vehicle to said AVs in advance of execution thereof.

11. The method of claim 10, further including the step of at least one of said AVs transmitting a challenge to IVMs broadcast by said reference vehicle, and wherein said signaling and broadcasting by said reference vehicle initiates an interactive challenge dialogue option for any of said AVs to challenge said IVMs broadcast by said reference vehicle.

12. A driver-adjustable sensor apparatus for monitoring, detecting and tracking AVs, for processing AVMs, for calculating AVM status data, and for recommending and displaying at least one maneuvering recommendation to a driver of a reference vehicle, comprising:
a. at least one driver-adjustable detection perimeter control switch disposed upon said sensor apparatus adapted for adjusting and setting at least one detection perimeter of said sensor;
b. at least one of an electromagnetic wave transmitter and an ultrasonic wave transmitter for generating and radiating at least one of an electromagnetic and an ultrasonic wave;
c. at least one of an electromagnetic wave receiver for receiving reflected electromagnetic waves and an ultrasonic wave receiver for receiving reflected ultrasonic waves;
d. at least one antenna;
e. at least one processor for processing AVMs, for calculating AVM status data, and for recommending and displaying said at least one maneuvering recommendation;
f. at least one input/output line coupled to said at least one processor for outputting said AVMs and said at least one maneuvering recommendation to at least one display;
g. said display for displaying said AVMs and said at least one maneuvering recommendation to a driver; and
h. at least one power source.

13. The apparatus of claim 12, wherein said at least one processor is coupled to at least one of said electromagnetic transmitter and said ultrasonic transmitter and is further coupled to at least one of said electromagnetic wave receiver and said ultrasonic wave receiver.

14. The apparatus of claim 12, wherein said AVM status data further comprises (but is not limited to) at least one of location data, direction of motion data, direction of relative motion data, range data, bearing data, speed data, closest point of approach data, collision probability data, and other driver-stipulated data pertaining to at least one of said AVs as compared with a reference vehicle, after detection of at least one of said AVs crossing a set detection perimeter of said reference vehicle.

15. The apparatus of claim 12, wherein said sensor apparatus is adapted for signaling and broadcasting intended vehicle movements (IVMs) of said reference vehicle to said AVs, and wherein said sensor apparatus is further adapted for receiving challenges to said IVMs from said AVs.

16. The apparatus of claim 12, wherein said sensor apparatus is further adapted for receiving at least one challenge from at least one of said AVs in response to said IVMs broadcasted by said reference vehicle.

17. The apparatus of claim 12, wherein said apparatus further comprises a speaker for outputting audible warning sounds to a driver including (but not limited to) at least one of a beep sound, a buzz sound, a bell sound, a chirp sound, and at least one warning sound preselected by said driver.

18. A driver-adjustable sensor system for improving intervehicular safety, comprising:
a. a driver for driving a reference vehicle;
b. at least one driver for driving at least one adjacent vehicle;
c. at least one method for improving intervehicular safety; and
d. at least one apparatus for monitoring, detecting and tracking AVs, for processing AVMs, for calculating AVM status data, and for recommending and displaying at least one maneuvering recommendation to said driver of said reference vehicle.

19. The system of claim 17, wherein said driver-adjustable sensor apparatus comprises at least one display subsystem for visually displaying adjacent vehicle data, adjacent vehicle movement data, AVM status data, AVM status data update data, and calculated maneuvering recommendations, and wherein said driver-adjustable sensor apparatus further comprises an information display screen, a control module, a transceiver/receiver module, at least one sensor module.

20. The system of claim 17, wherein said sensor apparatus includes a transceiver including at least one IVM broadcasting and receiving module adapted for sending IVMs to AVs and further adapted for receiving responses from AVs.

21. The system of claim 18, wherein said driver-adjustable sensor system further includes means for interacting with external traffic control apparatuses and systems including (but not limited to) at least one of a communicating traffic light and a communicating traffic sign and a CVISN system and a metro traffic control system.

22. A traffic control apparatus for governing and controlling the speed and movement of a vehicle toward an intersection, further comprising:
a. said traffic control apparatus further comprising a traffic light having green, yellow and red signal lights for signaling conventional traffic light signals when illuminated in sequence;
b. a processor having a clock and coupled to said signal lights for controlling the timing of illumination of each of said signal lights, wherein said processor sends a yellow light detected signal to a transceiver when said processor detects that said yellow light signal is illuminated;
c. said transceiver coupled to said processor and adapted for receiving said yellow light detected signal and further adapted for transmitting a yellow light warning signal in response thereto for transmission to said vehicle; and
d. at least one power source.

23. The apparatus of claim 22, wherein said traffic light apparatus further comprising said transceiver for transmitting said yellow light warning signal to said vehicle is further adapted to transmit at least one of a decelerate command signal and a stop command signal to said vehicle, forbidding said vehicle to proceed through said intersection until after receiving a green light signal.

24. A traffic light system for controlling the approach of a vehicle to an intersection, comprising:
a. a traffic control apparatus having a transmitter for transmitting a yellow light warning signal and further adapted for transmitting at least one of a decelerate command signal and a stop command signal to said vehicle; and
b. said vehicle, wherein said vehicle has a receiver for receiving said yellow light warning signal and at least one of said decelerate command signal and said stop command signal, wherein said vehicle also has a processor coupled to said receiver for responding to said signals, and wherein said processor is further coupled to at least one of the brakes and the engine of said vehicle in order to control said approach of said vehicle to said intersection.
